(19) United States
(12) Patent Application Publication
(10) Pub. No.: US 2026/0145278 A1
(43) Pub. Date: May 28, 2026

(54) SULFUR-RESISTANT AND CORROSION-RESISTANT LOW-CARBON ALLOY-BASED COILED TUBING AND PREPARATION METHOD THEREOF

(71) Applicant: SHINDA (TANGSHAN) CREATIVE OIL & GAS EQUIPMENT CO., LTD., Tangshan, Hebei (CN)

(72) Inventors: Jianliang DUAN, Tangshan, Hebei (CN); Runqiu GAO, Tangshan, Hebei (CN); Wenbin WU, Tangshan, Hebei (CN); Jianlei ZHAN, Tangshan, Hebei (CN); Guogang LIU, Tangshan, Hebei (CN); Jian DONG, Tangshan, Hebei (CN); Yueming LIU, Tangshan, Hebei (CN)

(21) Appl. No.: 19/107,281

(22) PCT Filed: Nov. 28, 2024
(86) PCT No.: PCT/CN2024/135102

§ 371 Date: Mar. 3, 2025

(30) Foreign Application Priority Data
Nov. 26, 2024 (CN) 202411703563.7

(51) Int. Cl. B23K 31/02; B23K 10/02; B23K 13/02; B23K 26/262; B23K 35/02; B23K 35/30; B23K 37/06; B23K 101/06; C21D 1/84; C21D 6/00; C21D 8/10; C21D 9/08; C22C 38/00; C22C 38/02; C22C 38/04; C22C 38/06; C22C 38/42; C22C 38/44; C22C 38/48; C22C 38/50; C22C 38/58

(52) U.S. Cl. CPC B23K 31/027; B23K 10/02; B23K 35/0261; B23K 35/3053; B23K 37/06; C21D 1/84; C21D 6/004; C21D 6/005; C21D 6/008; C21D 8/10; C21D 9/085; C22C 38/002; C22C 38/02; C22C 38/04; C22C 38/06; C22C 38/42; C22C 38/44; C22C 38/48; C22C 38/50; C22C 38/58; B23K 13/025; B23K 26/262; B23K 2101/06

(57) ABSTRACT

Provided are a sulfur-resistant and corrosion-resistant low-carbon alloy-based coiled tubing and a preparation method thereof. The sulfur-resistant and corrosion-resistant low-carbon alloy-based coiled tubing is prepared by subjecting a steel strip to butt welding, curling molding, tube blank welding, extrusion molding, weld heat treatment, and cooling in sequence, and the sulfur-resistant and corrosion-resistant low-carbon alloy-based coiled tubing includes the following components by mass percentage: 0.04% to 0.08% of C, 1.5% to 2.0% of Mn, 0.1% to 0.3% of Si, 0.1% to 0.3% of Cr, 0.05% to 0.3% of Mo, 0.04% to 0.07% of Nb, 0.005% to 0.025% of Ti, 0.01% to 0.05% of Al, not greater than 0.3% of Ni, not greater than 0.3% of Cu, not greater than 0.02% of P, not greater than 0.02% of S, and Fe and unavoidable impurities as a balance.

### CROSS REFERENCE TO RELATED APPLICATIONS

This application is a U.S. national stage application of International Patent Application No. PCT/CN2024/135102, filed on Nov. 28, 2024, which claims the benefit of and priority to Chinese Patent Application No. 2024111703563.7, filed on Nov. 26, 2024, each of which is hereby incorporated by reference herein in its entirety.

### TECHNICAL FIELD

The present disclosure relates to the technical field of coiled tubings, and in particular to a sulfur-resistant and corrosion-resistant low-carbon alloy-based coiled tubing and a preparation method thereof.

### BACKGROUND

At present, CT80 coiled tubing is generally used in oil and gas drilling and production. The CT80 coiled tubing is generally manufactured by high-frequency welding or laser welding with low-carbon and low-manganese steel strip as a raw material, and has a steel grade strength of only 80 steel grades. Therefore, although CT80 coiled tubing can meet the application environment for hydrogen sulfide well field operations, its low strength, short service life, insufficient pressure and load bearing capacity, and poor sulfur resistance and corrosion resistance affect the resource extraction rate in the oil and gas field. Moreover, as the well conditions for oil and gas resource extraction become increasingly complex, the CT80 coiled tubing is not enough to meet the resource extraction demands.

### SUMMARY

In view of this, the present disclosure provides a sulfur-resistant and corrosion-resistant low-carbon alloy-based coiled tubing and a preparation method thereof. In the present disclosure, plasma welding and optimized heat treatment processes improve grain refinement and structural uniformity of a steel strip weld, such that the tensile strength, yield strength, and corrosion resistance of the coiled tubing are significantly improved to be better than those of the traditional CT90 coiled tubing, and a comprehensive performance can reach 90 steel grades.

The present disclosure provides a sulfur-resistant and corrosion-resistant low-carbon alloy-based coiled tubing, the sulfur-resistant and corrosion-resistant low-carbon alloy-based coiled tubing being prepared by subjecting a steel strip to butt welding, curling molding, tube blank welding, extrusion molding, weld heat treatment, and cooling in sequence, and the sulfur-resistant and corrosion-resistant low-carbon alloy-based coiled tubing including the following components by mass percentage:
0.04% to 0.08% of C, 1.5% to 2.0% of Mn, 0.1% to 0.3% of Si, 0.1% to 0.3% of Cr, 0.05% to 0.3% of Mo. 0.04% to 0.07% of Nb, 0.005% to 0.025% of Ti, 0.01% to 0.05% of Al, not greater than 0.3% of Ni, not greater than 0.3% of Cu, not greater than 0.02% of P, not greater than 0.02% of S, and Fe and unavoidable impurities as a balance.

The present disclosure further provides a method for preparing the sulfur-resistant and corrosion-resistant low-carbon alloy-based coiled tubing, including the following steps:
S1, extending the steel strip by butt welding, and then subjecting a resulting weld region to rolling and deformation heat treatment;
S2, subjecting a treated steel strip obtained in S1 to the curling molding to obtain a round tube blank with a weld;
S3, welding the round tube blank obtained in S2, and then adding an extrusion roller to a rear side of a resulting molten pool before solidification and conducting the extrusion molding on the weld; and
S4, subjecting an extrusion molded weld obtained in S3 to the weld heat treatment and then air cooling to room temperature to obtain the sulfur-resistant and corrosion-resistant low-carbon alloy-based coiled tubing.

In some embodiments, in S1, the butt welding is conducted by plasma welding using a copper-plated welding wire of a manganese-molybdenum steel as a welding wire.

In some embodiments, in S1, the rolling and the deformation heat treatment refer to rolling the weld region while conducting a heat treatment, the rolling is conducted at a pressure of 4 T to 8 T and is reciprocated once, and the rolling and the deformation heat treatment are conducted at 600° C. to 750° C., and the rolling and the deformation heat treatment are conducted for 10 s each time.

In some embodiments, in S3, the welding is conducted by laser welding or high-frequency welding.

In some embodiments, in S4, the weld heat treatment includes simulated normalizing and tempering, where the simulated normalizing is conducted at a temperature of 900° C. to 940° C. under the following conditions: a furnace is heated by induction heating, a heating coil has a length of 1.5 m, a running speed is 2.8 m/min, air cooling is conducted after the heating is completed, and an air cooling section is 50 in long and then enters a water cooling zone where a resulting air-cooled product is cooled to room temperature; and the tempering is conducted at a temperature of 500° C. to 600° C. for 79.8 s, and a holding section of a tempering furnace is 4 m long.

Compared with the prior art, in some embodiments of the present disclosure, plasma welding is conducted to refine grains of a steel strip weld, making the structure uniform and the strength stable, thus avoiding reduction of the strength and corrosion resistance of a plate joint. Moreover, the heat treatment refines weld grains to make the tube structure more uniform, removes stress to allow the strength of an entire tube to be stable and make the structure uniform, thereby ultimately achieving high strength and strong corrosion resistance.

In some embodiments of the present disclosure, a tube body of the sulfur-resistant and corrosion-resistant low-carbon alloy-based coiled tubing is equivalent to a tube body of the CT90 coiled tubing in the aspects of resistance to hydrogen-induced cracking (HIC), resistance to sulfide stress cracking (SSC), and corrosion resistance in 95% N₂+5% O₂ environment. Moreover, the tube body of the sulfur-resistant and corrosion-resistant low-carbon alloy-based coiled tubing has a tensile strength greater than 669 MPa, a yield strength greater than 620 MPa, and an average hardness of 95 HRB. The metallographic structure is ferrite+pearlite. An average grain size of a metal in a weld, a heat-affected zone, and a parent material reaches not less than 10.0 grade, resulting in a comprehensive performance reaching 90 steel grades.

### BRIEF DESCRIPTION OF THE DRAWINGS

The present disclosure will be further described below with reference to the accompanying drawings.

FIG. 1 shows an equally divided cross-section of the weld in Example 1 of the present disclosure;

FIG. 2 shows an equally divided cross-section of the weld in Comparative Example 1 of the present disclosure;

FIG. 3 shows a corrosion product of the sample of Example 1 in Test Example 2 before cleaning;

FIG. 4 shows a corrosion product of the sample of Example 1 in Test Example 2 after cleaning:

FIG. 5 shows a corrosion product of the sample of CT90 in Test Example 2 before cleaning;

FIG. 6 shows a corrosion product of the sample of CT90 in Test Example 2 after cleaning;

FIG. 7 shows a surface of the specimen at the weld in Test Example 3;

FIG. 8 shows a metallographic structure of the equally divided cross-section at the weld in Test Example 3:

FIG. 9 shows a surface of the specimen at 90° from the weld in Test Example 3;

FIG. 10 shows a metallographic structure of the equally divided cross-section at 90° from the weld in Test Example 3;

FIG. 11 shows a surface of the specimen at 180° from the weld in Test Example 3;

FIG. 12 shows a metallographic structure of the equally divided cross-section at 180° from the weld in Test Example 3;

FIG. 13 shows a surface (front side) of the CT80-2 specimen after 96 h of corrosion test;

FIG. 14 shows a surface (back side) of the CT80-2 specimen after 96 h of corrosion test;

FIG. 15 shows a surface (front side) of the specimen in Example 1 after 96 h of corrosion test;

FIG. 16 shows a surface (back side) of the specimen in Example 1 after 96 h of corrosion test:

FIG. 17 shows a surface (front side) of the CT80-1 specimen after 96 h of corrosion test;

FIG. 18 shows a surface (back side) of the CT80-1 specimen after 96 h of corrosion test;

FIG. 19 shows a surface (front side) of the CT90 specimen after 96 h of corrosion test;

FIG. 20 shows a surface (back side) of the CT90 specimen after 96 h of corrosion test:

FIG. 21 shows a typical metallographic crack on the cross-section of the CT80-1 specimen:

FIG. 22 shows a typical metallographic crack on the cross-section of the CT90 specimen;

FIG. 23 shows a surface of the CT80-2 specimen after 720 h of corrosion test;

FIG. 24 shows a surface of the specimen in Example 1 after 720 h of corrosion test;

FIG. 25 shows a surface of the CT80-1 specimen after 720 h of corrosion test; and

FIG. 26 shows a surface of the CT90 specimen after 720 h of corrosion test.

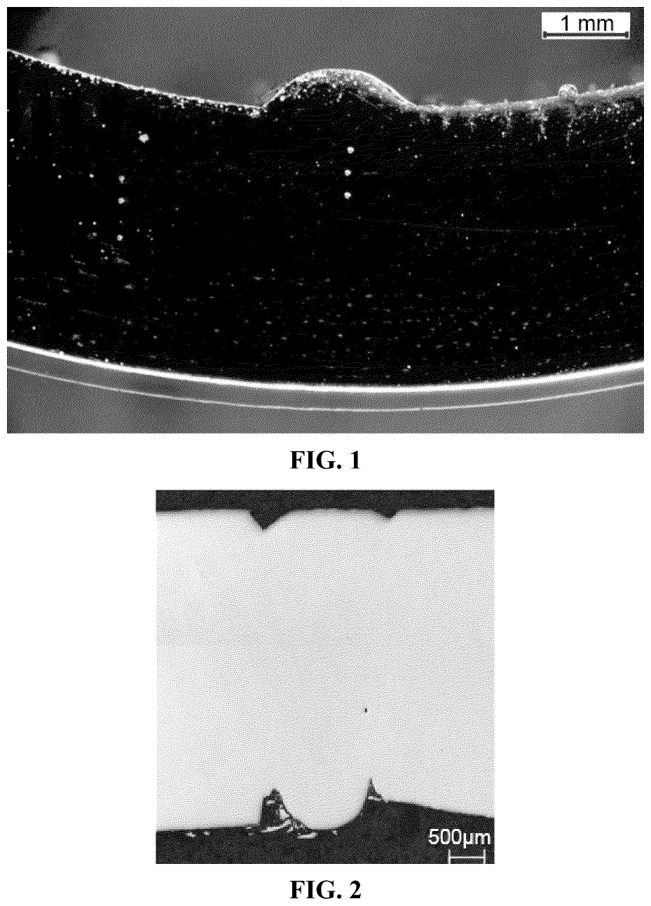

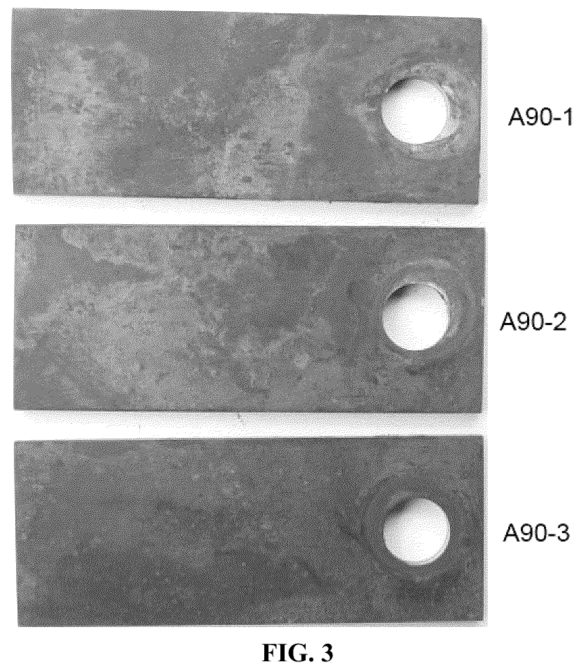

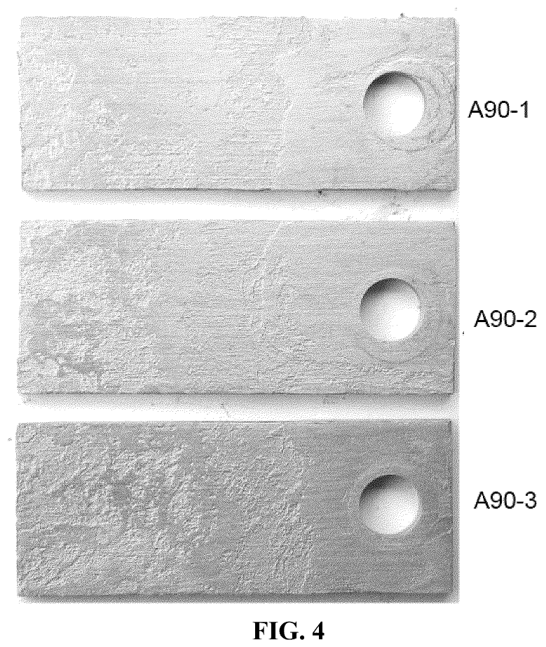

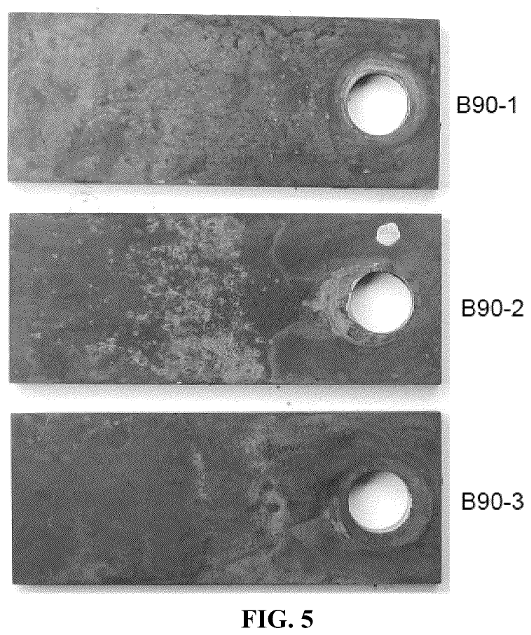

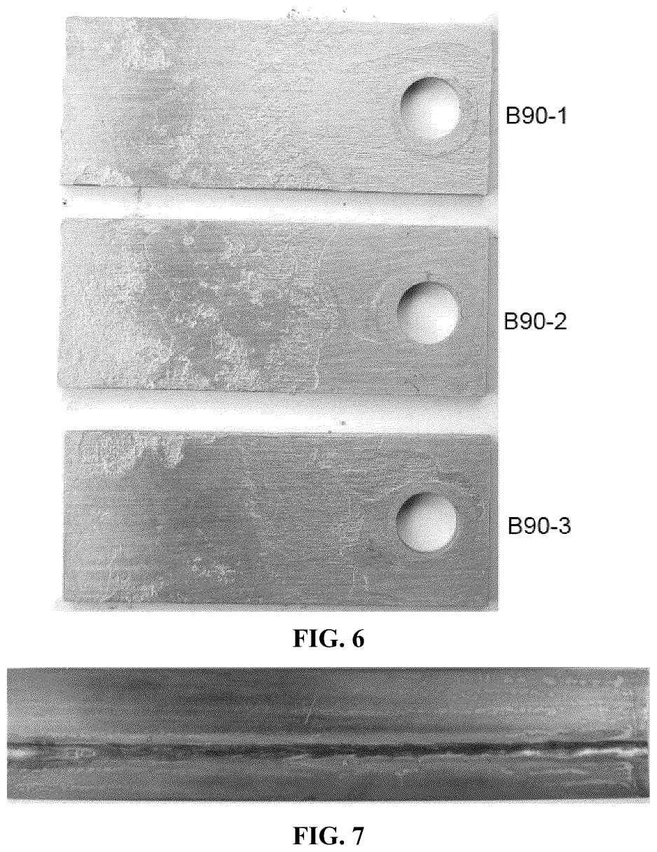

### DETAILED DESCRIPTION OF THE EMBODIMENTS

The technical solutions of the present disclosure will be clearly and completely described below in conjunction with embodiments of the present disclosure. Obviously, the described embodiments are only a part of, not all of, the embodiments of the present disclosure. All other embodiments obtained by those skilled in the art based on the embodiments of the present disclosure without inventive efforts shall fall within the scope of the present disclosure.

The present disclosure provides a sulfur-resistant and corrosion-resistant low-carbon alloy-based coiled tubing, the sulfur-resistant and corrosion-resistant low-carbon alloy-based coiled tubing being prepared by subjecting a steel strip to butt welding, curling molding, tube blank welding, extrusion molding, weld heat treatment, and cooling in sequence, and the sulfur-resistant and corrosion-resistant low-carbon alloy-based coiled tubing including the following components by mass percentage:
0.04% to 0.08% of C, 1.5% to 2.0% of Mn, 0.1% to 0.3% of Si, 0.1% to 03% of Cr, 0.05% to 0.3% of Mo, 0.04% to 0.07% of Nb, 0.005% to 0.025% of Ti, 0.01% to 0.05% of Al, not greater than 0.3% of Ni, not greater than 0.3% of Cu, not greater than 0.02% of P, not greater than 0.02% of S, and Fe and unavoidable impurities as a balance.

In the present disclosure, the C content affects corrosion rate and hardness of the coiled tubing. The higher the C content is, the more micro-electrochemical cells are formed, and the faster the corrosion rate of carbon steel is; while the lower the C content is, the lower the basic strength (hardness) of carbon steel is. Therefore, the C content is controlled to be 0.04% to 0.08% to seek a balance between the corrosion resistance and strength of the coiled tubing. Mn increases the strength of carbon steel. Si avoids the reduction of toughness. Ti and Al refine the grains. Compared with conventional CT90 raw materials, the coiled tubing has stronger corrosion resistance through adjustment of elements.

The present disclosure further provides a method for preparing the sulfur-resistant and corrosion-resistant low-carbon alloy-based coiled tubing, including the following steps:
S1, extending the steel strip by the butt welding, and then subjecting a resulting weld region to rolling and deformation heat treatment;
S2, subjecting a treated steel strip obtained in S1 to the curling molding to obtain a round tube blank with a weld;
S3, welding the round tube blank obtained in S2, and then adding an extrusion roller to a rear side of a resulting molten pool before solidification and conducting the extrusion molding on the weld; and
S4, subjecting an extrusion molded weld obtained in S3 to the weld heat treatment and air cooling to room temperature to obtain the sulfur-resistant and corrosion-resistant low-carbon alloy-based coiled tubing.

In some embodiments of the present disclosure, in S1, the butt welding is conducted by plasma welding using a high-strength copper-plated welding wire of a manganese-molybdenum steel as a welding wire. The plasma welding achieves single-sided welding and double-sided forming, avoiding oxidation of alloy steel, and the plasma welding results in a high melt depth to allow welding various wall thickness plates.

In some embodiments of the present disclosure, in S1, the rolling and the deformation heat treatment refer to rolling the weld region while conducting a heat treatment, the rolling is conducted at a pressure of 4 T to 8 T and is reciprocated once, and the rolling and the deformation heat treatment are conducted at 600° C. to 750° C., and the rolling and the deformation heat treatment are conducted for 10 s each time. The rolling and deformation heat treatment can refine grains of a steel strip weld and make the structure uniform and the strength stable, thus avoiding reduction of the strength and corrosion resistance of a plate joint.

In some specific embodiments of the present disclosure, in S2, the weld has a gap of 1 mm to 2 mm.

In some embodiments of the present disclosure, in S3, the welding is conducted by laser welding or high-frequency welding.

In some embodiments of the present disclosure, in S4, the weld heat treatment includes simulated normalizing and tempering, where the simulated normalizing is conducted at a temperature of 900° C. to 940° C. under the following conditions: a furnace is heated by induction heating, a heating coil has a length of 1.5 m, a running speed is 2.8 m/min, air cooling is conducted after the heating is completed, and an air cooling section is 50 m long and then enters a water cooling zone where a resulting air-cooled product is cooled to room temperature; and the tempering is conducted at a temperature of 500° C. to 600° C. for 79.8 s, and a holding section of a tempering furnace is 4 in long. In some specific embodiments, the simulated normalizing is conducted at 910° C. and the tempering is conducted at 550° C. In some other specific embodiments, the simulated normalizing is conducted at 940° C. and the tempering is conducted at 550° C.

In some embodiments of the present disclosure, extrusion molding+laser welding or high-frequency welding are adopted. During the coiling molding, rolling rollers roll up the strip steel gradually to form a round tube blank with an open gap. A pressing amount of extrusion rollers is adjusted to control the weld gap to 1 mm to 2 mm, and then welding is conducted. After the welding is completed, an extrusion roller is added to the rear side of a molten pool before solidification, and the rolling amount is increased until the gap between molding two edges of the steel strip is 0, achieving welding and extrusion molding. The weld is then subjected to a heat treatment to achieve a combination of deformation strengthening and phase transformation strengthening, thereby greatly improving the weld strength.

In order to further illustrate the present disclosure, the following examples are provided for detailed description. All raw materials used in the following examples of the present disclosure are commercially-available products.

CT80-1 involved in the specific embodiment of the present disclosure consists of the following components by mass percentage:
C 0.046%, Si 0.162%, Mn 0.745%, P 0.011%, S 0.001%. Cr 0.558%, Ni 0.040%, Mo 0.184%, Cu 0.206%, W 0.004%, Ca 0.001%, V 0.006%, Ti 0.020%, Nb 0.017%, Al 0.041%, Zr 0.011%, Co 0.007%, B 0.00001%, As 0.008%, Pb 0.001%, Sn 0.001%, Sb 0.074%, Bi 0.023%, and Fe and unavoidable impurities as a balance,

CT80-2 involved in the specific embodiment of the present disclosure consists of the following components by mass percentage:
C 0.062%, Si 0.253%, Mn 0.763%, P 0.008% S 0.001%, Cr 0.679%, Ni 0.144%, Mo 0.160%, Cu 0.262%, W 0.010%, Ca 0.001%, V 0.005%, Ti 0.017%, Nb 0.017%, Al 0.043%, Zr 0.008%, Co 0.009%, B 0.00001%, As 0.004%, Pb 0.001%, Sn 0.001%, Sb 0.050%, Bi 0.015%, and Fe and unavoidable impurities as a balance.

CT90 involved in the specific embodiment of the present disclosure consists of the following components by mass percentage:
C 0.123%, Si 0.405%, Mn 0.898%, P 0.006%, S 0.0001%, Cr 0.546%, Ni 0.056%, Mo 0.159%, Cu 0.243%, W 0.004%, Ca 0.001%, V 0.005%, Ti 0.035%, Nb 0.018%, Al 0.061%, Zr 0.011%, Co 0.006%, B 0.00001%, As 0.008%, Pb 0.002%, Sn 0.002%, Sb 0,070%, Bi 0.022%, and Fe and unavoidable impurities as a balance.

### Example 1

A sulfur-resistant and corrosion-resistant low-carbon alloy-based coiled tubing consisted of the following components by mass percentage:
C 0.0605%, Mn 1.7890%, Si 0.1675%, Cr 0.2080%, Mo 0.1375%, Nb 0.0620%, Ti 0.0100%, Al 0.0180%, Ni 0.0001%, Cu 0.0275%, P 0.0110%, S 0.0020%, and Fe and unavoidable impurities as a balance.

A method for preparing the sulfur-resistant and corrosion-resistant low-carbon alloy-based coiled tubing was performed as follows:
S1. A steel strip was expanded by plasma welding, where a welding wire was a high-strength copper-plated welding wire of a manganese-molybdenum steel. A resulting weld region was subjected to rolling and deformation heat treatment, where the rolling was conducted at a pressure of 6 T and reciprocated once, and the rolling and deformation heat treatment were conducted at 735° C., and the rolling and the deformation heat treatment were conducted for 10 s each time. A resulting treated steel strip was air-cooled to room temperature.
S2. The treated steel strip obtained in S1 was subjected to curling molding to obtain a round tube blank with a weld of (1.5±0.5) mm.
S3. The round tube blank obtained in S2 was subjected to laser welding, and then an extrusion roller was added to a rear side of a resulting molten pool before solidification and extrusion molding was conducted on the weld.
S4. An extrusion molded weld obtained in S3 was subjected to simulated normalizing at 910° C. and 940° C. under the following conditions: a furnace was heated by induction heating, a heating coil had a length of 1.5 m, a running speed was 2.8 m/min, air cooling was conducted after the heating was completed, and an air cooling section was 50 m long and then entered a water cooling zone where a resulting air-cooled product was cooled to room temperature; and then a resulting normalized product was subjected to tempering at 550° C. for 79.8 s, with a holding section of a tempering furnace being 4 m long, and the sulfur-resistant and corrosion-resistant low-carbon alloy-based coiled tubing was obtained after air cooling to room temperature.

### Comparative Example 1

This comparative example was the same as Example 1, except that: the simulated normalizing was conducted at 910° C., and in S3, only laser welding was conducted without extrusion molding, specifically: laser welding was conducted on the round tube blank obtained in S2.

### Comparative Example 2

This comparative example was the same as Example 1, except that: the simulated normalizing was conducted at 890° C.

### Comparative Example 3

This comparative example was the same as Example 1, except that: the simulated normalizing was conducted at 950° C.

### Comparative Example 4

This comparative example was the same as Example 1, except that: the simulated normalizing was conducted at 980° C.

### Test Example 1

The coiled tubing samples of 38.1 mm×3.7 mm obtained in Example 1 and Comparative Examples 1 to 4 and their weld performances were tested, and the results are shown in Table 1.

TABLE 1
Test results of coiled tubing samples and weld performances thereof

| | Simulated | Tensile | Yield | | | |
|---|---|---|---|---|---|---|
| | normalizing | strength | strength | Elongation | Fatigue | |
| Item | temperature | (MPa) | (MPa) | (%) | times | Evaluation |
| Example 1 | 910° C. | 740 | 682 | 26 | 409 | Qualified |
| | 940° C. | 737 | 680 | 26 | 402 | Qualified |
| Comparative | 910° C. | 745 | 687 | 22 | 352 | Fatigue times lower |
| Example 1 | | | | | | than acceptance |
| | | | | | | value |
| Comparative | 890° C. | 752 | 701 | 23 | 358 | Yield strength |
| Example 2 | | | | | | exceeding |
| | | | | | | acceptance value |
| Comparative | 950° C. | 710 | 603 | 17 | 205 | Poor weld |
| Example 3 | | | | | | formation not |
| | | | | | | meeting acceptance |
| | | | | | | criteria |
| Comparative | 980° C. | 733 | 670 | 25 | 375 | Fatigue times lower |
| Example 4 | | | | | | than acceptance |
| | | | | | | value |

### Test Example 2

The raw materials of the sulfur-resistant and corrosion-resistant low-carbon alloy-based coiled tubing in Example 1 and the raw materials of the conventional CT90 steel plate were subjected to a nitrogen and oxygen environment corrosion test under: N₂ content of 95%, O₂ content of 5%, total pressure of 10 MPa, temperature of 150° C., 5% of NaCl solution, and cycle of 168 h. The test results are shown in Table 2.

TABLE 2
Results of nitrogen and oxygen corrosion test on steel plates

| | | | | | Weight | | | Average |
|---|---|---|---|---|---|---|---|---|
| | | | | | before | Weight | Corrosion | corrosion |
| | Specimen | Thickness | Width | Length | test | after test | rate | rate |
| Item | number | (mm) | (mm) | (mm) | (g) | (g) | (mm/a) | (mm/a) |
| Example | A90-1 | 2.90 | 19.90 | 49.65 | 21.5490 | 21.1432 | 1.1256 | 1.2643 |
| 1 | A90-2 | 2.90 | 19.86 | 49.79 | 21.3937 | 20.9210 | 1.3100 | |
| | A90-3 | 2.89 | 19.92 | 49.78 | 21.4733 | 20.9829 | 1.3573 | |
| CT90 | B90-1 | 2.92 | 19.81 | 49.85 | 21.6872 | 20.7889 | 2.4893 | 2.3956 |
| | B90-2 | 2.90 | 19.83 | 49.89 | 21.7230 | 20.8707 | 2.3607 | |
| | B90-3 | 2.97 | 20.10 | 49.89 | 22.2700 | 21.4127 | 2.3369 | |

As shown in Table 2, the present disclosure improves the corrosion resistance of the coiled tubing by adjusting the elements of raw materials.

### Test Example 3

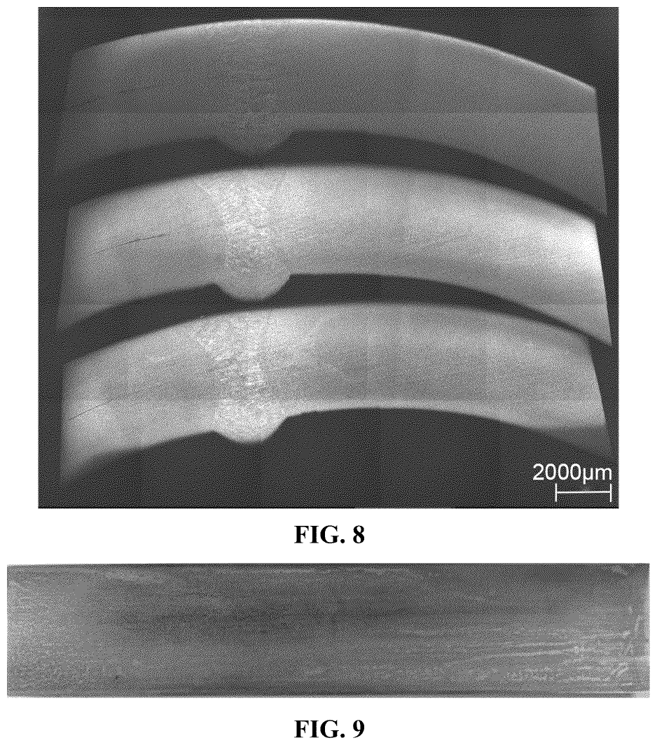

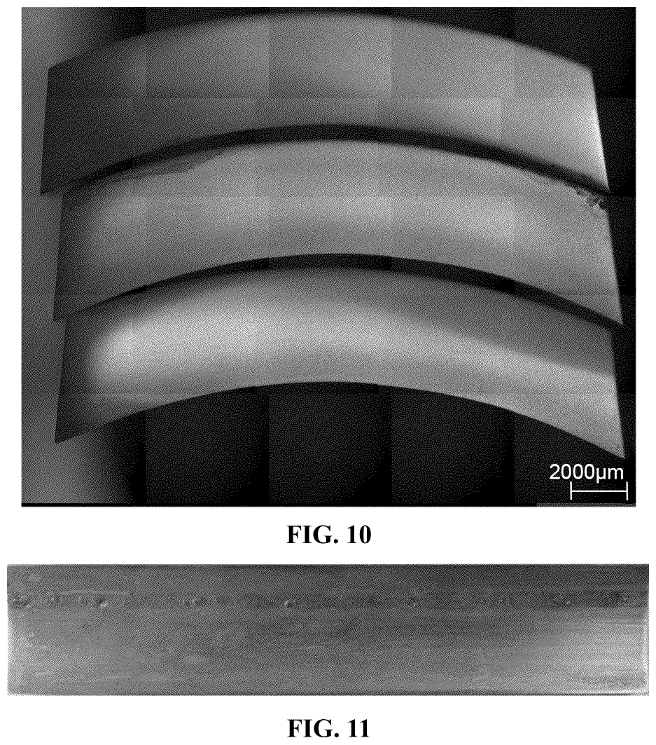

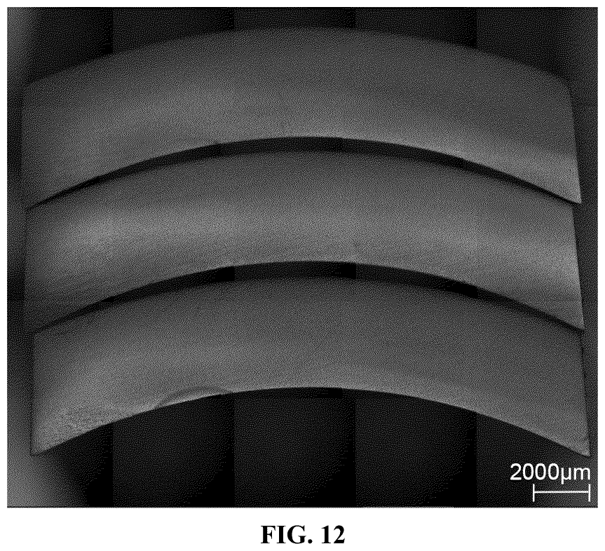

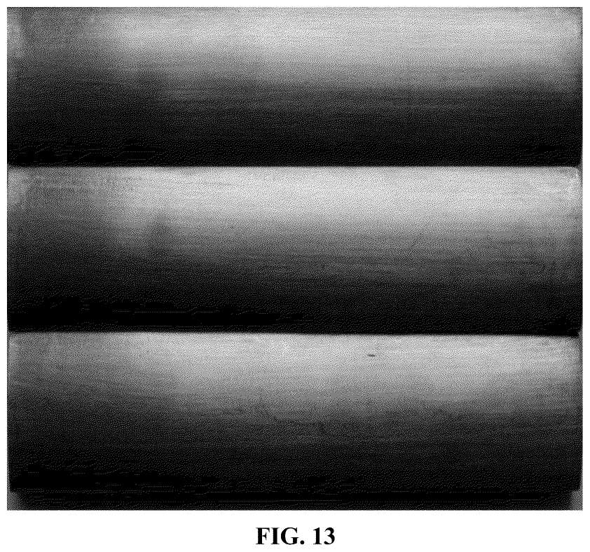

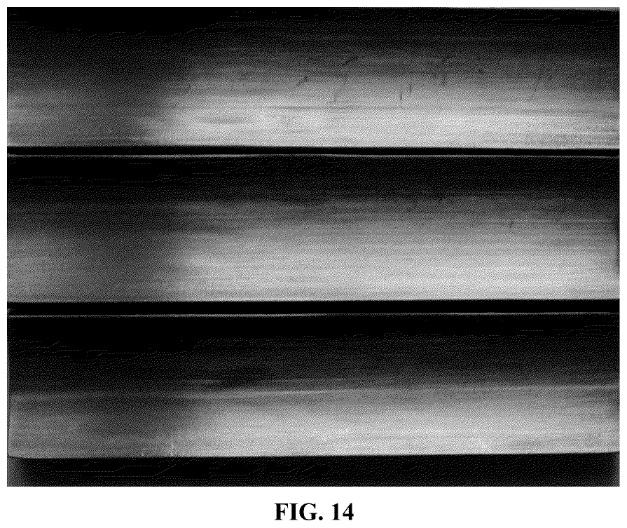

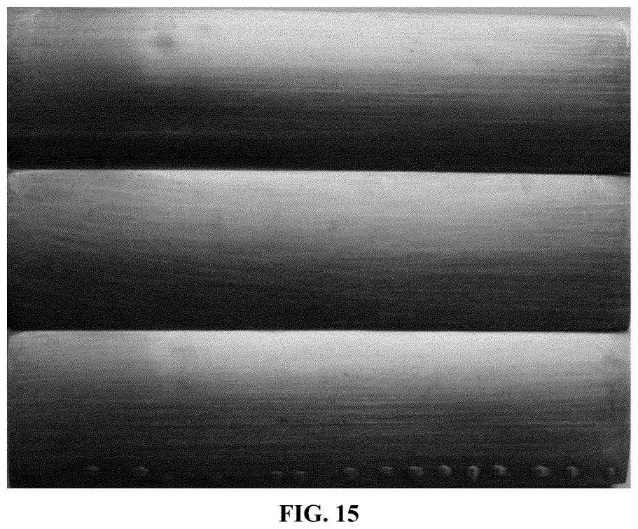

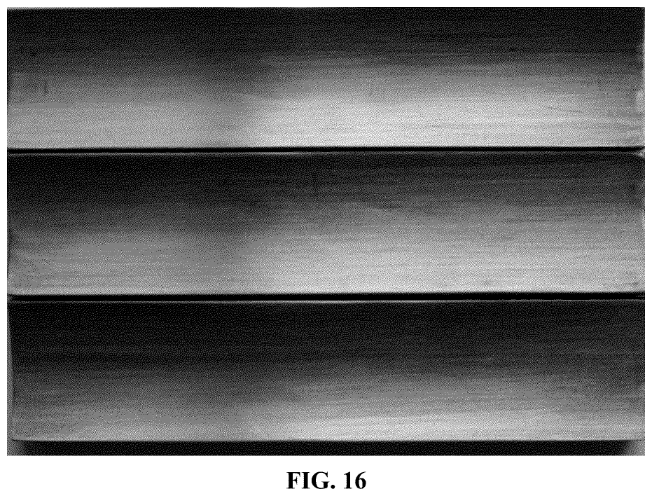

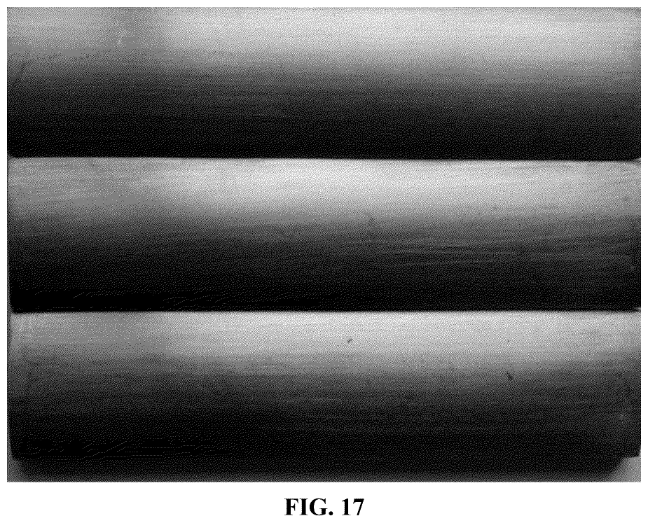

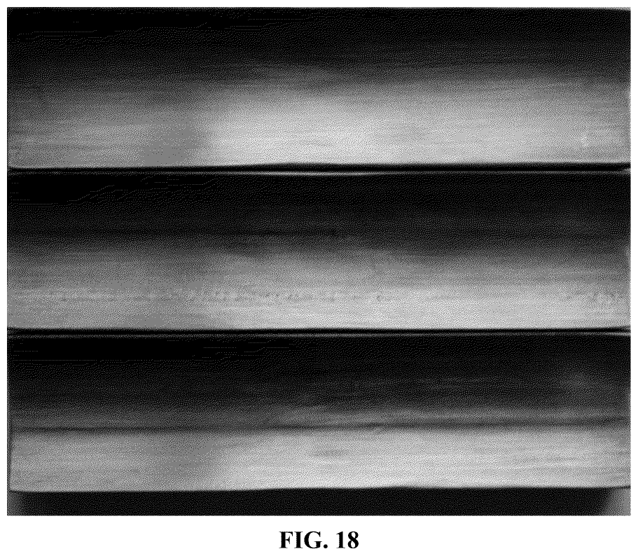

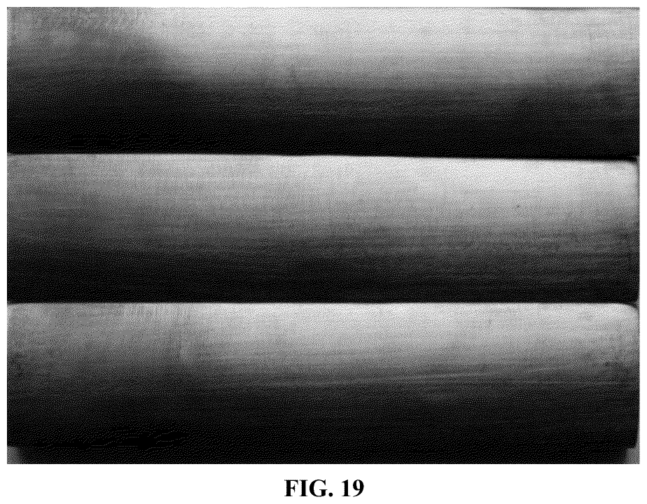

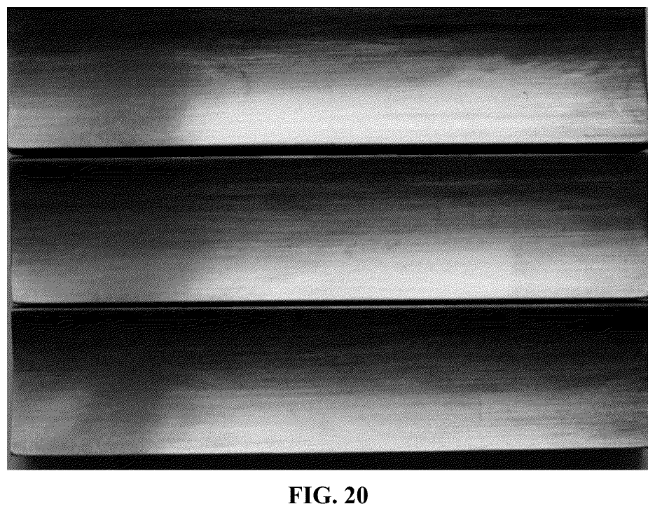

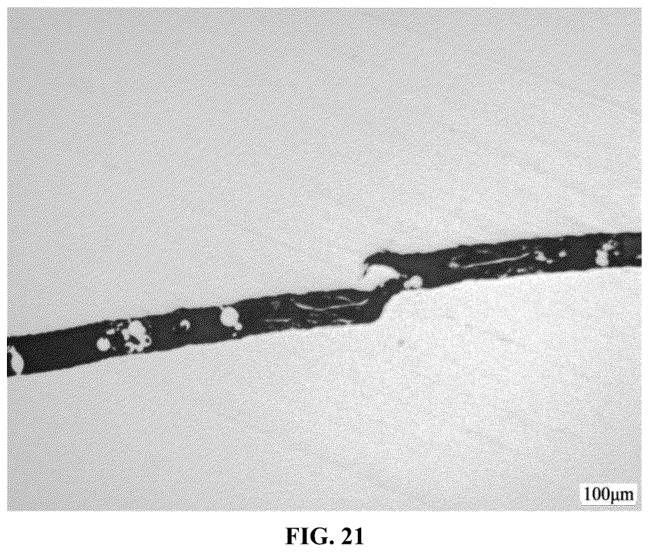

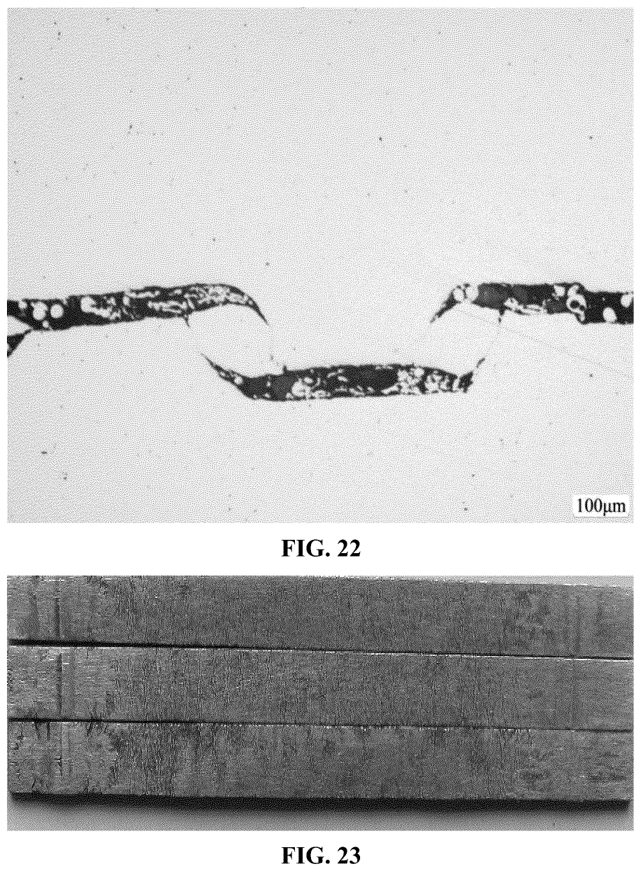

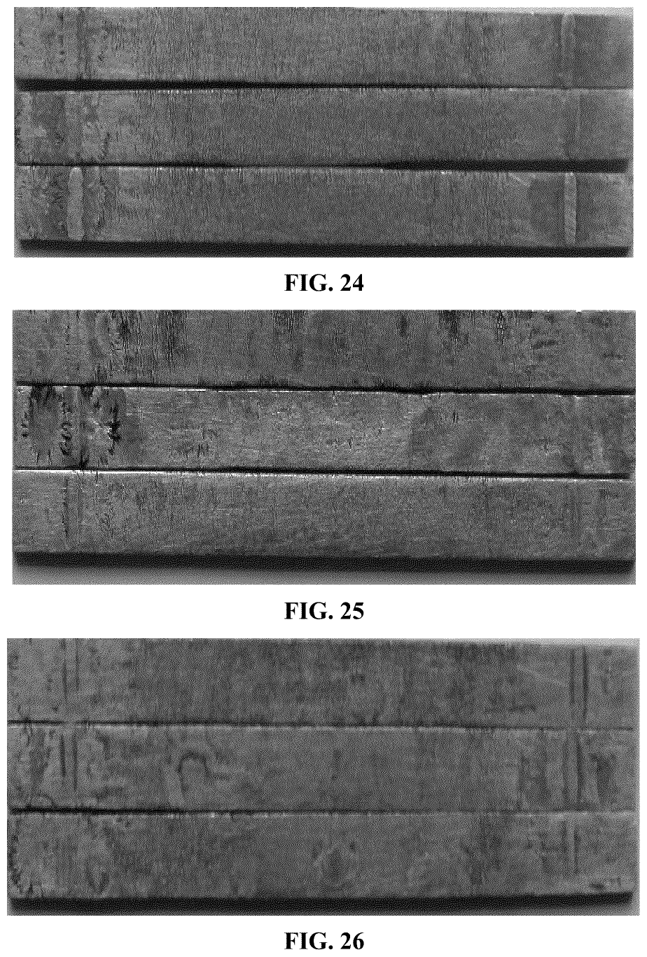

The HIC resistance of the weld of the coiled tubing in Example 1 was evaluated as follows: samples were taken at the weld position, 90° and 180° from the weld on the tube, and a sample surface was polished. The test was conducted according to the NACETM0284 standard using a solution A After immersion for 96 h, the samples were taken out and their internal cracking was observed by the equally divided section method. The test results are shown in FIG. 7 to FIG. 12.

Test conditions were: P_{H2S}=0.1 MPa, NACE-A solution, (25±3°) C, cycle 96 h.

### Parameters During the Test:

The prepared solution had a pH value of 2.75, the initial solution had a pH value of 3.03, and an initial hydrogen sulfide concentration was 2,409 mg/L; the final solution had a pH value of 3.65, and a final hydrogen sulfide concentration was 2,512 mg/L.

As shown in FIG. 7 to FIG. 12, there are a few cracks in the core of the specimen at the weld position, but the crack rate meets AP15L requirements, and no cracks are found in the specimens at 90° and 180° from the weld.

### Test Example 4

HIC test was conducted on the coiled tubing of Example 1 (1 #), and the coiled tubing samples of CT80-1 (2 #), CT80-2 (3 #), and CT90 (4 #).

(1) The HIC test was based on the standard NACE TM0284-2016, and the specific conditions were as follows:

Temperature: 23° C. to 26° C., deoxygenating gas: 99.999% N₂, test gas: 99.9% H₂S, test solution A, test cycle 96 h, hydrogen sulfide concentration in the solution: 2,460 mg/L, hydrogen sulfide concentration in the solution after saturation for 1 h: 2,396 mg/L, initial pH value=2.7, test start pH value=2.9, test end pH value=3.7, nominal size of the specimen L×W×t (mm)=100×20×4, sampling direction: longitudinal direction of the tube body. HIC test results are shown in Table 3.

TABLE 3
HIC test results for coiled tubing

| | | Inspection result | | | | | | | | | | | |
|---|---|---|---|---|---|---|---|---|---|---|---|---|---|
| | | Cross-section 1 | | | Cross-section II | | | Cross-section III | | | Average | | |
| Specimen | Sample | CLR | CTR | CSR | CLR | CTR | CSR | CLR | CTR | CSR | CLR | CTR | CSR |
| number | marking | % | % | % | % | % | % | % | % | % | % | % | % |
| 3# | 31 | 0.00 | 0.00 | 0.00 | 0.00 | 0.00 | 0.00 | 0.00 | 0.00 | 0.00 | 0.00 | 0.00 | 0.00 |
| | 32 | 0.00 | 0.00 | 0.00 | 0.00 | 0.00 | 0.00 | 0.00 | 0.00 | 0.00 | 0.00 | 0.00 | 0.00 |
| | 33 | 0.00 | 0.00 | 0.00 | 0.00 | 0.00 | 0.00 | 0.00 | 0.00 | 0.00 | 0.00 | 0.00 | 0.00 |
| 1# | 11.00 | 0.00 | 0.00 | 0.00 | 0.00 | 0.00 | 0.00 | 0.00 | 0.00 | 0.00 | 0.00 | 0.00 | 0.00 |
| | 12.00 | 0.00 | 0.00 | 0.00 | 0.00 | 0.00 | 0.00 | 0.00 | 0.00 | 0.00 | 0.00 | 0.00 | 0.00 |
| | 13.00 | 0.00 | 0.00 | 0.00 | 0.00 | 0.00 | 0.00 | 0.00 | 0.00 | 0.00 | 0.00 | 0.00 | 0.00 |
| 2# | 21.00 | 0.00 | 0.00 | 0.00 | 0.00 | 0.00 | 0.00 | 0.00 | 0.00 | 0.00 | 0.00 | 0.00 | 0.00 |
| | 22.00 | 0.00 | 0.00 | 0.00 | 20.87 | 9.85 | 2.06 | 0.00 | 0.00 | 0.00 | 6.96 | 3.28 | 0.69 |
| | 23.00 | 0.00 | 0.00 | 0.00 | 0.00 | 0.00 | 0.00 | 0.00 | 0.00 | 0.00 | 0.00 | 0.00 | 0.00 |
| 4# | 41.00 | 61.19 | 32.99 | 20.19 | 0.00 | 0.00 | 0.00 | 44.28 | 15.23 | 3.37 | 35.16 | 16.07 | 7.85 |
| | 42.00 | 0.00 | 0.00 | 0.00 | 0.00 | 0.00 | 0.00 | 35.54 | 20.10 | 7.14 | 11.85 | 6.70 | 2.38 |
| | 43.00 | 0.00 | 0.00 | 0.00 | 0.00 | 0.00 | 0.00 | 0.00 | 0.00 | 0.00 | 0.00 | 0.00 | 0.00 |

### Test Example 5

SSC test was conducted on the coiled tubing of Example 1 (1 #), and the coiled tubing samples of CT80-1 (2 #), C180-2 (3 #), and CT90 (4 #).

The test was based on the standards NACE TM0177-2016 and ISO 7539-2:1989 (by four-point bending loading method), and the specific conditions were as follows:

Temperature: 23° C. to 26° C., pressure: 1 atm, deoxygenated gas: 99.999% N₂, test gas: 99.9% H₂S, test solution A, test cycle 720 h, initial pH value=2.7, test start pH value=2.9, test end pH value=3.7, sample nominal dimensions L×W×t (mm)=67.5×4.5×1.6, sampling direction: longitudinal direction of the tube body. SSC results are shown in Table 4.

TABLE 4
SSC test results

| Specimen | Sample | Loaded | |
|---|---|---|---|
| number | marking | stress/MPa | Test result |
| 3# | 31 | 552 × 0.85 | No fracture after 720 h, no cracks found when observing |
| | | | the working section under 10× magnification |
| | 32 | 552 × 0.85 | No fracture after 720 h, no cracks found when observing |
| | | | the working section under 10× magnification |
| | 33 | 552 × 0.85 | No fracture after 720 h, no cracks found when observing |
| | | | the working section under 10× magnification |
| 1# | 11 | 621 × 0.85 | No fracture after 720 h, no cracks found when observing |
| | | | the working section under 10× magnification |
| | 12 | 621 × 0.85 | No fracture after 720 h, no cracks found when observing |
| | | | the working section under 10× magnification |
| | 13 | 621 × 0.85 | No fracture after 720 h, no cracks found when observing |
| | | | the working section under 10× magnification |
| 2# | 21 | 552 × 0.85 | No fracture after 720 h, no cracks found when observing |
| | | | the working section under 10× magnification |
| | 22 | 552 × 0.85 | No fracture after 720 h, no cracks found when observing |
| | | | the working section under 10× magnification |
| | 23 | 552 × 0.85 | No fracture after 720 h, no cracks found when observing |
| | | | the working section under 10× magnification |
| 4# | 41 | 621 × 0.85 | No fracture after 720 h, no cracks found when observing |
| | | | the working section under 10× magnification |
| | 42 | 621 × 0.85 | No fracture after 720 h, no cracks found when observing |
| | | | the working section under 10× magnification |
| | 43 | 621 × 0.85 | No fracture after 720 h, no cracks found when observing |
| | | | the working section under 10× magnification |

The above examples are merely some embodiments of the present disclosure, and the description thereof is specific and detailed, but should not be construed as limiting the scope of the present disclosure. It should be noted that those of ordinary skill in the art can further make several variations and improvements without departing from the concept of the present disclosure, and all of these fall within the scope of the present disclosure. Therefore, the scope of the present disclosure shall be subject to the appended claims.

1. A sulfur-resistant and corrosion-resistant low-carbon alloy-based coiled tubing, the sulfur-resistant and corrosion-resistant low-carbon alloy-based coiled tubing being prepared by subjecting a steel strip to butt welding, curling molding, tube blank welding, extrusion molding, weld heat treatment, and cooling in sequence, and the sulfur-resistant and corrosion-resistant low-carbon alloy-based coiled tubing comprising the following components by mass percentage:
0.04% to 0.08% of C, 1.5% to 2.0% of Mn, 0.1% to 0.3% of Si, 0.1% to 0.3% of Cr, 0.05% to 0.3% of Mo, 0.04% to 0.07% of Nb, 0.005% to 0.025% of Ti, 0.01% to 0.05% of Al, not greater than 0.3% of Ni, not greater than 0.3% of Cu, not greater than 0.02% of P, not greater than 0.02% of S, and Fe and unavoidable impurities as a balance.

2. A method for preparing the sulfur-resistant and corrosion-resistant low-carbon alloy-based coiled tubing of claim 1, comprising the following steps:
S1, extending the steel strip by the butt welding, and then subjecting a resulting weld region to rolling and deformation heat treatment;
S2, subjecting a treated steel strip obtained in S1 to the curling molding to obtain a round tube blank with a weld;
S3, welding the round tube blank obtained in S2, and then adding an extrusion roller to a rear side of a resulting molten pool before solidification and conducting the extrusion molding on the weld; and
S4, subjecting an extrusion molded weld obtained in S3 to the weld heat treatment and then air cooling to room temperature to obtain the sulfur-resistant and corrosion-resistant low-carbon alloy-based coiled tubing.

3. The method of claim 2, wherein in S1, the butt welding is conducted by plasma welding using a copper-plated welding wire of a manganese-molybdenum steel as a welding wire.

4. The method of claim 2, wherein in S1, the rolling is conducted at a pressure of 4 tonnes to 8 tonnes and is reciprocated once.

5. The method of claim 2, wherein in S1, the rolling and the deformation heat treatment refer to rolling the weld region while conducting a heat treatment, the rolling is conducted at a pressure of 4 tonnes to 8 tonnes and is reciprocated once, and the rolling and the deformation heat treatment are conducted at a temperature of 600° C. to 750° C., and the rolling and the deformation heat treatment are conducted for 10 seconds each time.

6. The method of claim 2, wherein in S2, the weld has a gap of 1 mm to 2 mm.

7. The method of claim 2, wherein in S3, the welding is conducted by laser welding or high-frequency welding.

8. The method of claim 2, wherein in S4, the weld heat treatment comprises simulated normalizing and tempering, the simulated normalizing is conducted at a temperature of 900° C. to 940° C., and the tempering is conducted at a temperature of 500° C. to 600° C.

9. The method of claim 8, wherein the simulated normalizing is conducted at 910° C. and the tempering is conducted at 550° C.

10. The method of claim 8, wherein the simulated normalizing is conducted at 940° C. and the tempering is conducted at 550° C.
